(19) United States
(12) Patent Application Publication
(10) Pub. No.: US 2001/0051531 A1
(43) Pub. Date: Dec. 13, 2001

(54) Method and apparatus for global computer network parking meter system

(76) Inventors: Tara Chand Singhal, Torrance, CA (US); Mukunda Singhal, Torrance, CA (US)

Correspondence Address: TARA CHAND SINGHAL, P.O. Box 5075, Torrance, CA, 90510, US

(21) Appl. No.: 09/757,985

(22) Filed: Jan. 10, 2001

Related U.S. Application Data
(60) Provisional application No. 60/175,995, filed on Jan. 11, 2000.

(51) Int. Cl. H04B 1/38

(52) U.S. Cl. 455/556; 455/557; 340/932.2; 194/902

(57) ABSTRACT

This invention discloses a parking meter system having a (I) parking meter and a (ii) central system on a global computer network, wherein the parking meter is activated by the central system. The parking meter is adapted with a cellular telephone device with an embedded central processing unit with parking meter function, whereby the function interfaces with the central computer system for the purpose of activation/deactivation of the parking meter and in collection of parking fees. The invention also discloses a dual-use parking meter system where the parking meter may have a coin box, a coin insertion slot with a coin sensor, and a coin status function logic embedded in the adapted telephone device, wherein on inserting coins for parking fee payment, the central system is able to send meter use status for display in the adapted cellular telephone device's display screen.

### BACKGROUND

In the United States, parking meters are common and are used in many places by the local municipalities for collecting parking fees. The people, who park their vehicles in metered parking places, have to feed coins in the parking meters. The city staff enforces the collection of parking fees and issues citations for parking violations. People do not like receiving parking citations and think of them as a nuisance. The meters need to be fed with coins and quite often people do not have an adequate amount of coins or underestimate the time they will use the parking space and have to pay a parking fine. Many times people overpay the parking meters if they cannot use the time for which they fed the coins for in the meter.

Recent parking meter improvements use electronics such as the use of liquid crystal display timers instead of mechanical controls and dial timers. Some meters may also accept parking fees by insertion of a prepaid card issued by a city by pre-paying the parking fees in advance. There is a need for parking meters that are more efficient for the public in how they are used and how they function and more efficient for the city in how the city manages and maintains them.

Therefore it is an objective of the present invention, to make parking meters more efficient for the public to use. It is also an objective of the invention to make parking meters more efficient for the city to maintain.

### SUMMARY

This invention discloses a parking meter system having a (I) parking meter and a (ii) central system on a global computer network, wherein the parking meter is activated by the central system. The parking meter is adapted with a cellular telephone device with an embedded central processing unit with parking meter function, whereby the function interfaces with the central computer system for the purpose of activation/deactivation of the parking meter and in collection of parking fees.

The invention also discloses a dual-use parking meter system where the parking meter may have a coin box, coin insertion slot with a coin sensor, and a coin status function logic embedded in the adapted telephone device, wherein on inserting coins for parking fee payment, the central system is able to send meter use status for display on the adapted cellular telephone device's display screen.

The central system interfaces with the parking meter function logic and maintains parking meter status in the form of a static database which contains parking meter identification, meter ownership identification, and parking meter-rate attributes; and a dynamic database which contains meter use status, and a billing reference.

The billing reference may have a user telephone number and a user identification number, whereby the user is identified to the central system by the identification number and is billed for the parking fees by the telephone number.

The public may use this dual-use parking meter by either keying in on the adapted cellular telephone keypad an identification and a billing reference number, or inserting coins in the coin slot. The adapted cellular telephone display screen displays the meter use status.

A city may monitor the use of their parking meters via a web page interface to the central computer system. The central system extracts a group of parking meters' specific static and dynamic data and delivers the same to the city's computer system. Additionally, the city's computer system may be a mobile device and the specific data is then delivered wirelessly.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram that illustrates an apparatus and method having features of the present invention;

FIGS. 2A-2B are block diagrams that illustrate a central system having features of the present invention;

FIGS. 3A-3D show a parking meter device having features of the present invention;

FIGS. 4A-4D are block diagrams that illustrate databases having features of the present invention;

FIGS. 5A-5B are simplified illustrations of web pages that can be generated by the central system for the city having features of the present invention;

FIG. 5C is a simplified illustration of a web page that can be generated by the central system for the user having features of the present invention; and

FIGS. 6A-6B are block diagrams that outline the parking meter system operation having features of the present invention.

### DESCRIPTION

Introduction

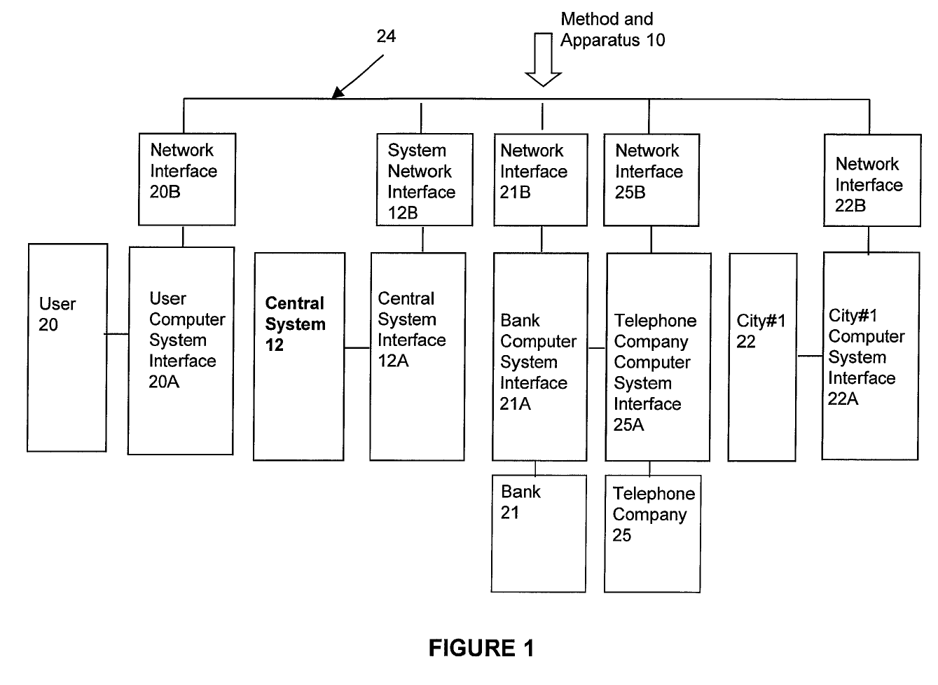

Referring initially to FIG. 1, a method and apparatus 10 having features of the present invention can include a central system 12, a central system interface 12A, at least one computer system interface 20A for a parking meter user 20, at least one or more city computer system Interface 22A for a city 22 (one is illustrated), one bank computer system interface 21A for bank 21 and telephone company computer system interface 25A for telephone company 25.

As provided herein, the present invention provides a parking meter system with a (i) parking meter adapted with a cellular telephone, and (ii) a central system on a global computer network. As an overview, the present invention allows the user 20 to activate and deactivate the parking meter and pay the parking fees by connecting to the central system. The parking fees are paid by reference to the user's billing and identification data, where the parking fees are billed to the user as part of the telephone bill. The central system subsequently effecting an electronic fund transfer of parking fee funds from the telephone company to the city. The present invention also allows the city to manage the parking meters. Preferred and optional aspects of the method and apparatus 10 are described below. The headings are provided for the convenience of the reader.

Central System 12

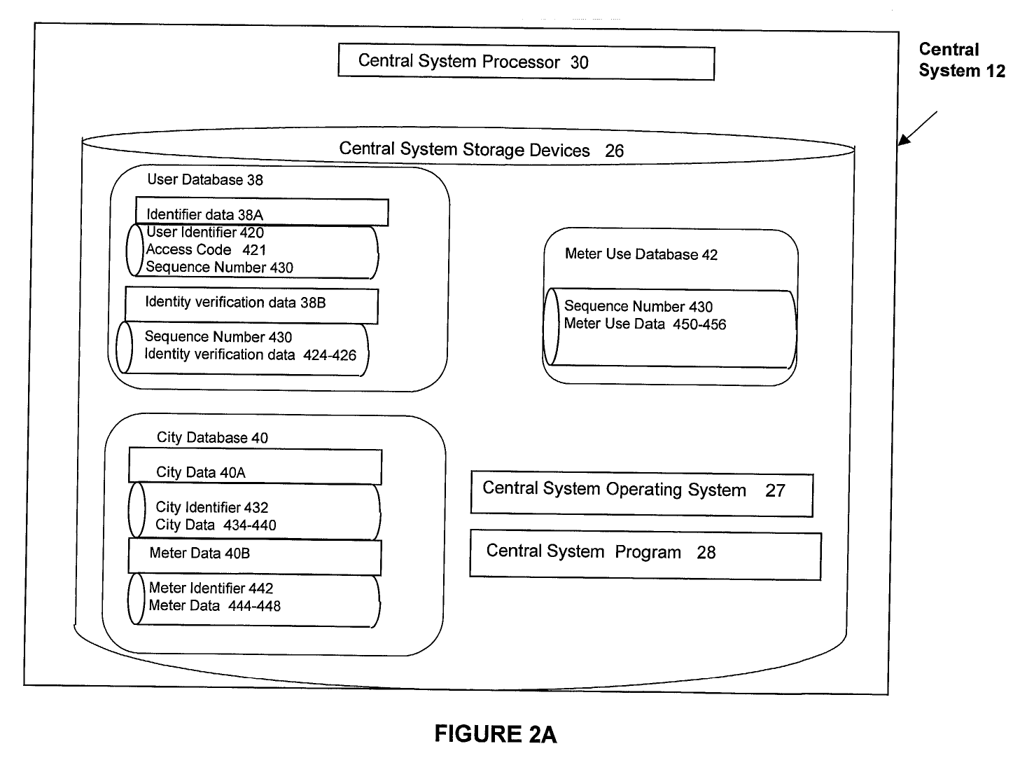

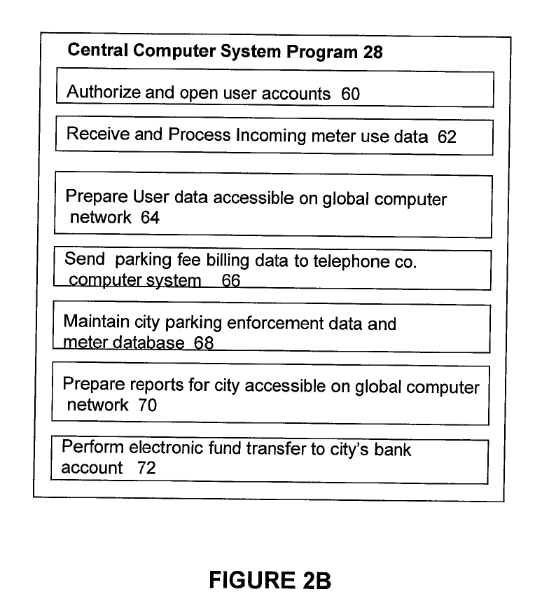

Referring to FIG. 2A, the central system 12 includes (i) a central system storage device 26, (ii) a central system operating system 27 stored in the central system storage device 26, (iii) a central system program 28 stored in the central system storage device 26, (iv) and a central system processor 30 connected to the central system storage device 26.

The central system processor 30 can include one or more conventional CPU's. The central system processor 30 is preferably capable of high volume processing and database searches.

The central system storage device 26 can include one or more magnetic disk drives, magnetic tape drives, optical storage units, CD-ROM drives and/or flash memory. The central system device 26 also contains a plurality of databases used in the processing of transactions pursuant to the present invention. For example, as illustrated in FIG. 2A, the central system storage device 26 can include a user database 38, a city database 40, and a meter use database 42.

Referring back to FIG. 1, the central system 12 includes a system network interface 12B that allows the central system 12 to communicate with the user 20, and the city 22. Conventional internal or external modems may serve as the system network interface 12B. In a preferred embodiment, the system network interface 12B is connected to the city computer system interface 22A, and the parking meter user computer system interface 20A, on the global computer network 24.

Preferably, the central system interface 12A can include an input device (not shown), such as a keyboard, mouse or voice recognition software and a display that allows access to the central system 12.

The network interface 20B allows the user 20 to communicate with the central system 12. Conventional internal or external modems may serve as the network interface 20B. In a preferred embodiment, the network interface 20B is connected to the central system interface 12A on the global computer network 24. Alternately, the network interface 20B can be connected by other electronic, voice and/or traditional communication systems that allow the user 20 to interact with the central system interface 12A.

Preferably, the interface 20A can include an input device, such as a keyboard, mouse or voice recognition software and a display that allows the user 20 to interact with the network interface 20B.

The city network interface 22B allows the city 22 to communicate with the central system 12. Conventional internal or external modems may serve as the city network interface 22B. In a preferred embodiment, the city network interface 22B is connected to the central system interface 12A on the global network 24. Alternately, the city network interface 22B can be connected by other electronic, voice and/or traditional communication systems that allow the city 22 to interact with the central system interface 12A.

Preferably, the city computer system interface 22A can include an input device, such as a keyboard, mouse or voice recognition software and a display that allows access to the central system 12.

The bank computer system interface 21A allows the central system 12 to communicate with the bank 21 for effecting electronic fund transfers. Conventional internal or external modems may serve as the network interface 21B. In a preferred embodiment, the network interface 21B is connected to the central system interface 12A on the global network 24. Alternately, the network interface 21B can be connected by other electronic, voice and/or traditional communication systems that allow the central system to interact with the bank computer system interface 21A.

The telephone company computer interface 25A allows the central system 12 to communicate with the telephone company 25 for transferring billing data. Conventional internal or external modems may serve as the network interface 25B. In a preferred embodiment, the network interface 25B is connected to the central system interface 12A on the global network 24. Alternately, the network interface 25B can be connected by other electronic, voice and/or traditional communication systems that allow the central system to interact with the telephone company computer system interface 25A.

Central Computer System Program 28

Referring to FIG. 2B, the central system program 28 provides the functions of (i) authorizing and opening user accounts 60, (ii) receiving and processing incoming meter use data 62, (iii) preparing user data accessible on the global computer network 64, (iv) sending parking fee billing data to telephone company computer system 66, (v) maintaining city parking enforcement data 68, (vi) preparing reports for city accessible on the global computer network 70, and (vii) performing electronic fund transfer to the city of aggregated parking fee funds 72.

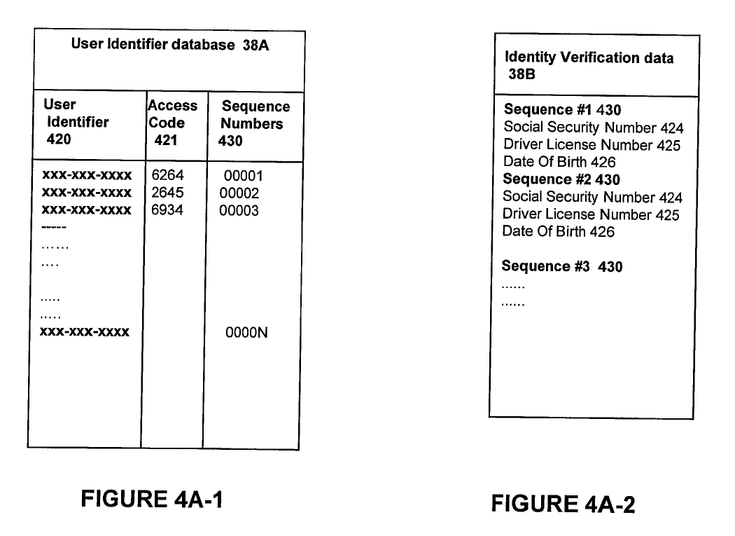

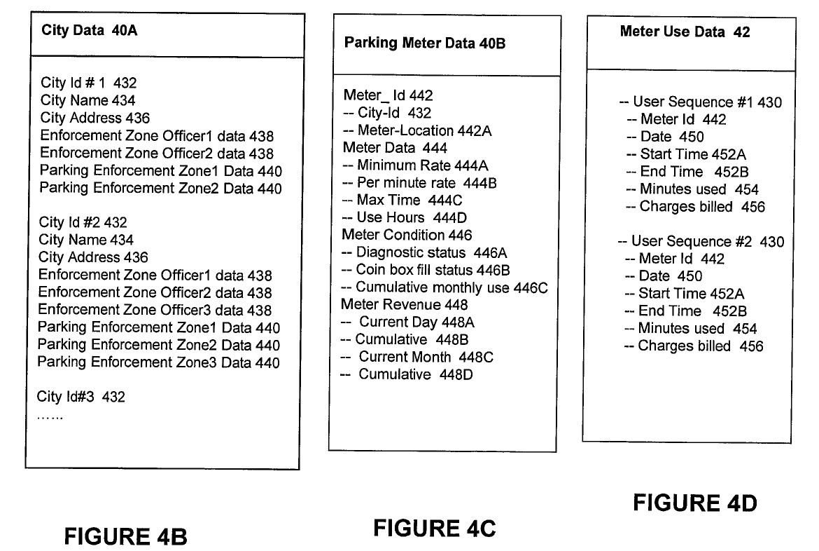

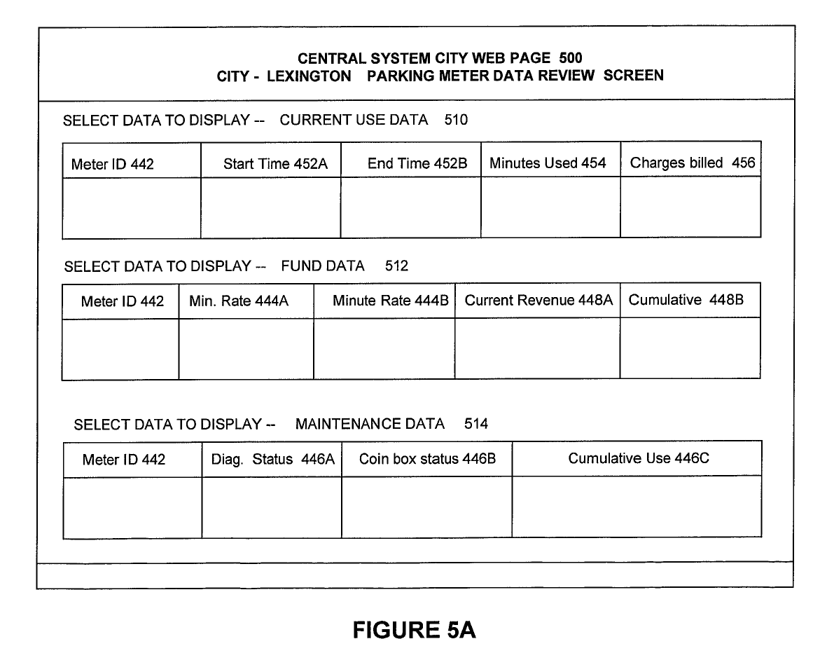

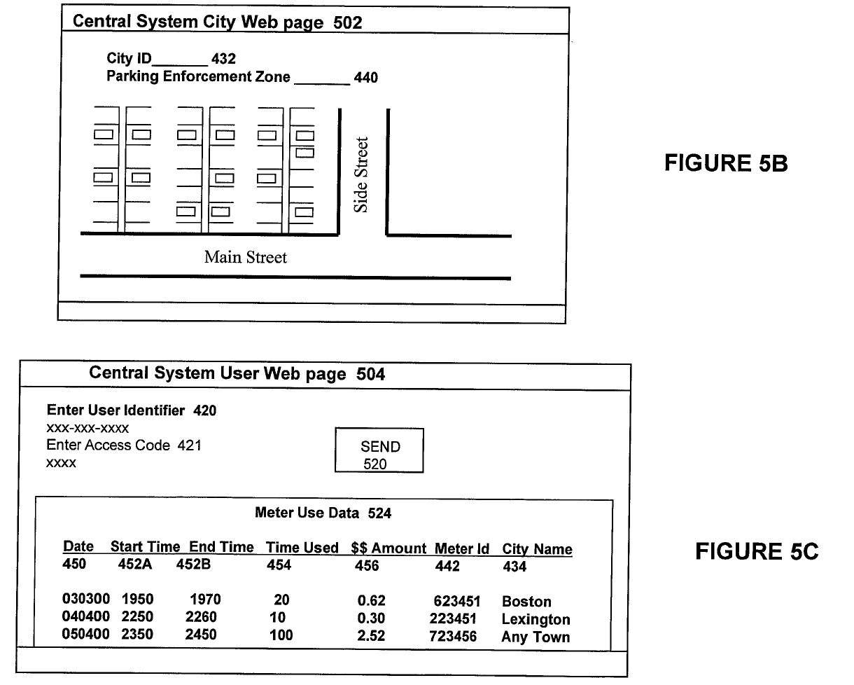

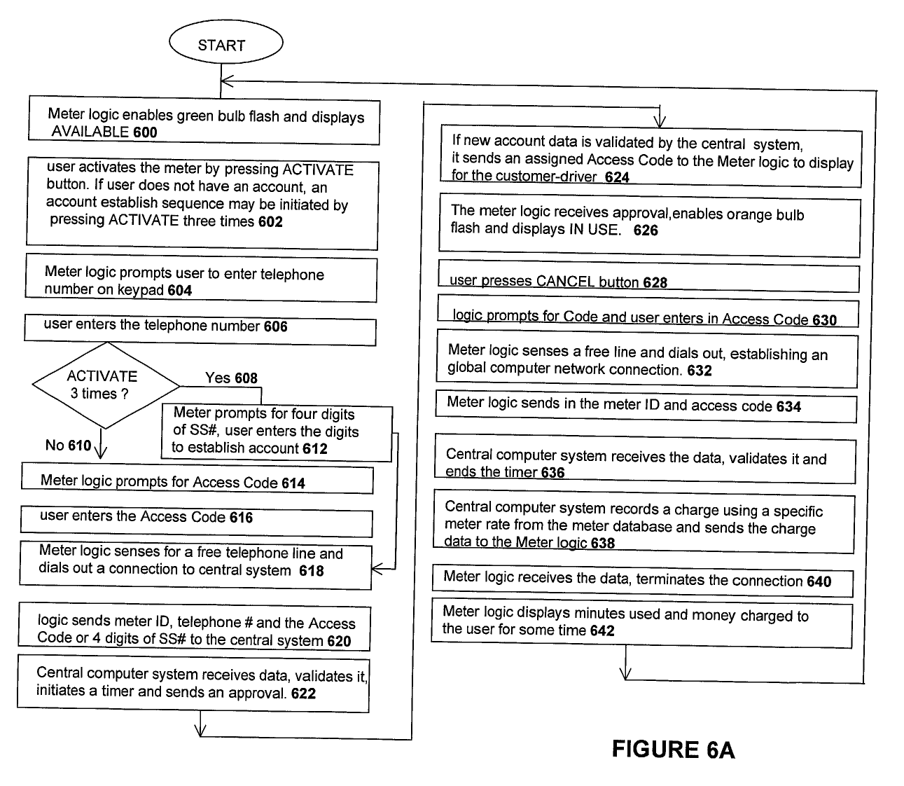

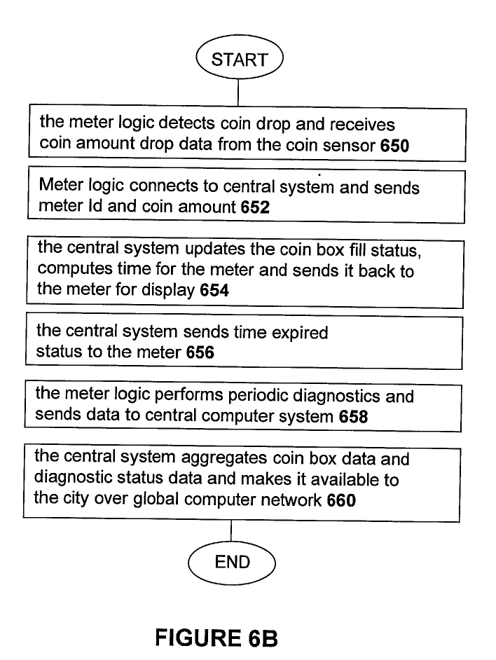

These functions are described later with reference to FIGS. 4A-D, FIGS. 5A-C and FIGS. 6A-B. FIGS. 4A-D describe the databases, FIGS. 5A-C describe the web pages and FIGS. 6A-6B describe the operation.

Parking Meter

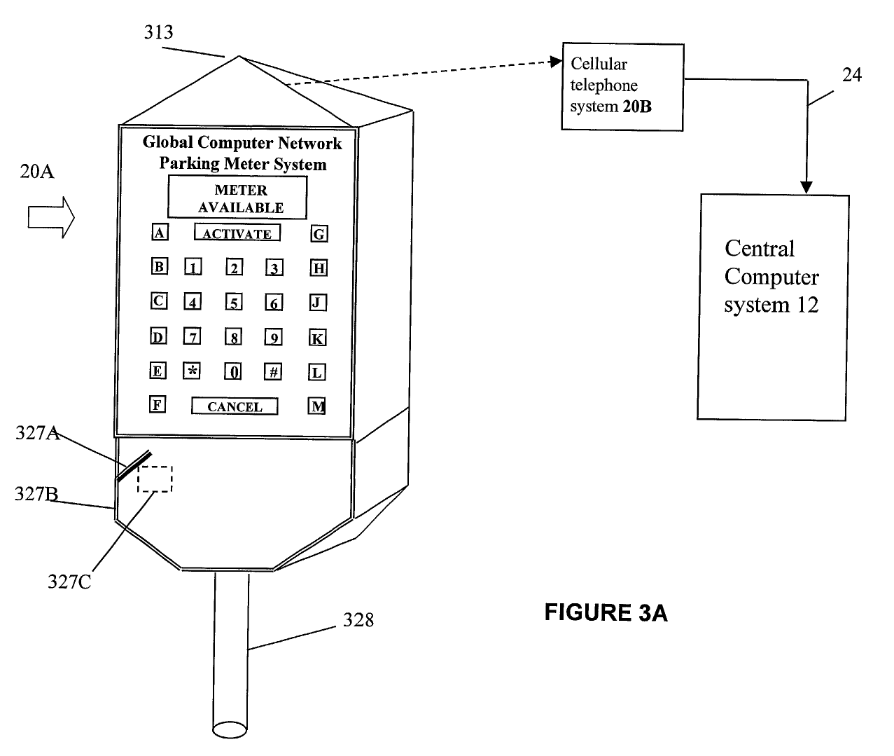

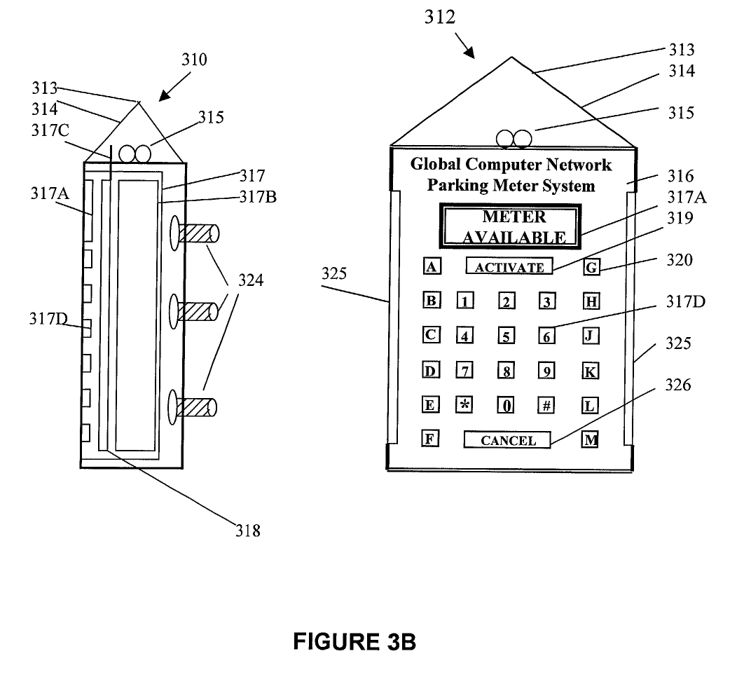

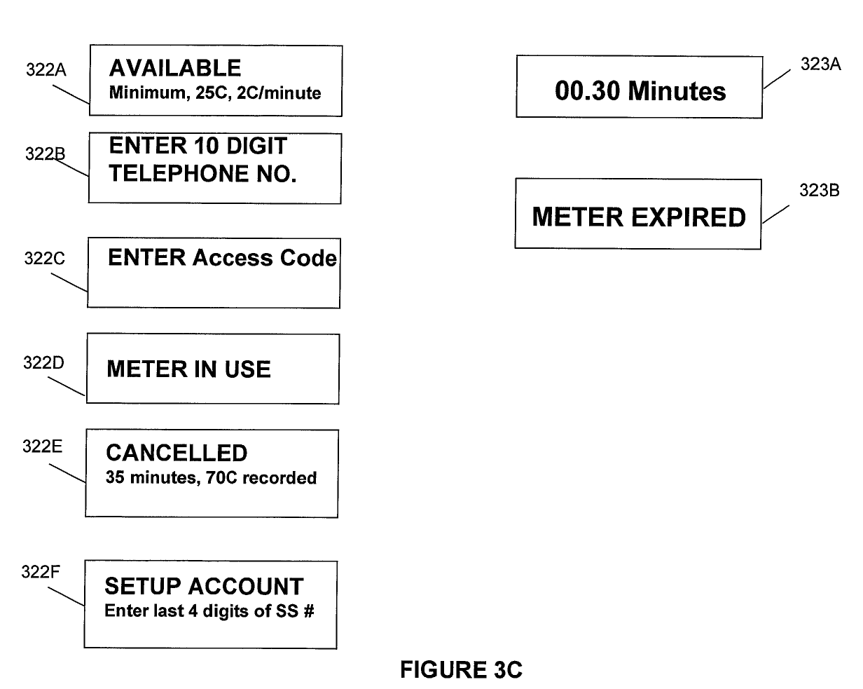

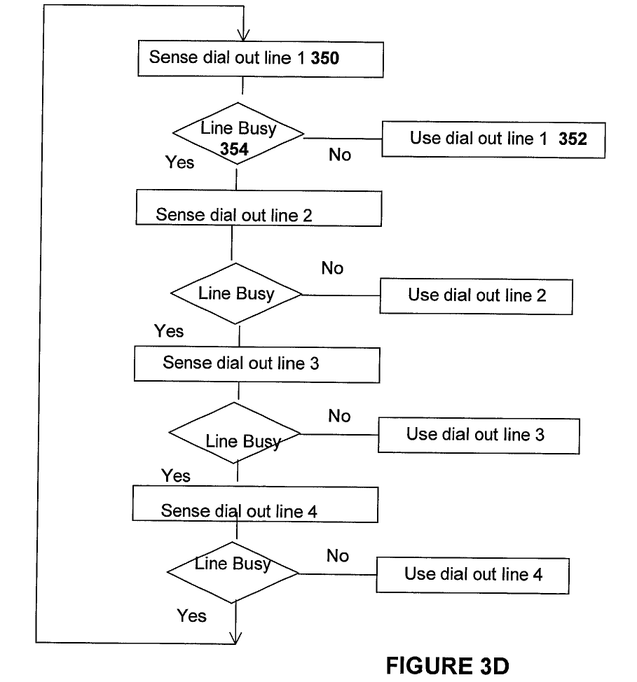

With respect to FIG. 3A, the parking meter system has a parking meter 20A that communicates with a central computer system 12 via a cellular telephone network 20B and global computer network 24. The parking meter may also have a coin box 327B, a coin insertion slot 327A and a coin sensor 327C. The meter may be mounted on a pole 328.

The communication between the parking meter and the central system over the global computer network is performed using a prior art protocol. The Wide Area Protocol (WAP) and similar other protocols such as IMODE and some others are being used for communication between a wireless device and a computer system on a global computer network.

With respect to FIG. 3B, the parking meter has a front view 312 and a side view 310. It incorporates a cellular telephone 317 adapted for parking meter logic 318, with a display 317A, antenna 317C, numeric keypad 317D and battery 317B. There may also be an ACTIVATE button 319 and a CANCEL button 326, an alphabetic keypad 320, in a rugged housing with a conical dome 313 with glass sides 314, with two bulbs 315. One bulb may radiate green light and the other one may radiate orange light through the glass sides 314 in the dome 313. View 310 shows attachment means 324 by which the meter may be affixed to a structure. Also the sides of the meter may have solar panels 325 for charging battery 317B.

With respect to FIG. 3C, examples of some of the displays show, meter available for use 322A, meter prompting for entry of telephone number 322B, the meter prompting for entry of access code 322C, meter in use 322D, meter canceled 322E and to establish an account 322F. For a dual-use mode, where coins would be used it shows time remaining 323A and meter expired 323B.

With respect to FIG. 3D, it shows flow chart of use of multiple telephone lines or data channels. Preferably, each meter has access to multiple lines and the logic senses which line is free for the connection. A large group of meters in a city may share a few telephone lines. Therefore, the meter logic senses dial out line 1 (350). It checks if the line is busy (354); if not it uses line 1 (352). If line 1 is busy, it senses line 2 and so on.

Central System Databases 38-42

With reference to FIGS. 2A, 4A-1 and 4A-2, the user database 38 contains data specifically related to the user 20. FIG. 4A-1 shows: a user identifier 420 that may be a ten-digit telephone number, and may be used to identify the user to the central system; an access code 421, that may be a 4 digit numeric or alphanumeric sequence, that may have been selected by the user, for verification of the user; and a user sequence number 430. The user sequence number 430 is assigned to the user for the purpose of the central system maintaining relevant data related to the user.

FIG. 4A-2 shows verification data that is required at the time of establishing an account. A user may establish an account at the parking meter itself at the time of first use of any parking meter. The verification data may be social security number, driver license number, date of birth or any other personal data. This data is anchored by the user sequence number 430. This verification data may be pre-stored in the central system. Alternatively, this data may be retrieved from a third party computer system such as the telephone company computer system or a credit verification company database, each time a new account is established.

With reference to FIG. 2A, 4B and 4C, the city database 40 maintains City data 40A and parking meter data 40B. The city data 40A can store a city Id 432, city name 434, city address 436, city parking enforcement officer data 438, and city parking enforcement zone data 440.

The parking meter data 40B can store meter Id data 442, meter data 444, meter condition data 446 and meter revenue data 448. The meter Id data 442 may include City Id 432 and meter location data 442A. The meter data 444 may include minimum rate 444A, per minute rate 444B, maximum time allowed 444C, and meter use hours 444D. The meter condition data 446 may include diagnostic status data 446A, coin box fill status 446B, cumulative monthly use time 446C. The meter revenue data 448 may include current day revenue 448A, cumulative daily revenue 448B, current month and year revenue 448C, and cumulative yearly revenue 448D.

With reference to FIG. 2A and 4D, a meter use database 42 maintains meter use data. The meter use data includes details of a meter use such as user sequence 430, meter Id 442, meter use date 450, meter use start time 452A, meter use end time 452B, minutes used 454 and charges billed 456. If the meter use is through the coins, similar data is maintained without the user sequence 430. Then the charges billed 456 becomes the coins used in the meter.

Central System Web Pages 500-504

As provided herein, the central system program 28 is operative with the central system processor 30 to generate one or more web pages on the world wide web. A city can monitor use of its parking meters over the global computer network via web pages from the central computer system.

As a simplified illustration, FIGS. 5A-B show the use of the parking meter data by a city over the global computer network. FIG. 5A shows a web page 500 with meter data review screen. It shows meter current use data 510, fund data 512 and maintenance data 514. The current use data 510 shows for each meter, the current use status such as start time, end time, minutes used and charges billed. The fund data 512 shows the rate for the meter and how much funds are being collected by each meter coin box and the funds being transferred to city's bank account by electronic fund transfer. The maintenance data 514 shows the diagnostic status, coin box status, and cumulative use of the meter to set up a diagnostic schedule.

FIG. 5B shows web page 502 with the graphical display of meter data by a parking enforcement zone. For each parking enforcement zone 440 selected, the layout of parking spaces, along with meter activity data may be displayed. The meter activity may indicate coin use, non-coin use, meter active, and meter available.

FIG. 5C illustrates a user system web page 504 having features of the present invention. The system web page 504 can be displayed on the user computer system interface 20A when the user 20 connects with the central system 12. The user system web page 504 includes (i) entry of a user identifier 420, access code 421 and a SEND icon 520.

After the user 20 enters the required information and clicks the SEND icon 520, the central system 12 receives and validates the user identifier 420. In response the system displays meter use data 524 specific to the user.

Operation

FIGS. 6A-6B illustrate the operation of the parking meter system. FIG. 6A illustrates the operation where the user opens an account and pays the parking fees by a billing and identification number. FIG. 6B illustrates the operation when the parking fees are paid by inserting coins. In these simplified illustration, not all of these steps may be used, other steps may be used and these steps may not necessarily be in the order illustrated.

With reference to FIG. 6A, at step 600 parking meter logic enables green bulb flash and/or displays AVAILABLE on the parking meter display. At step 602, if the user has a prior established account at the central computer system, the user activates the meter by pressing ACTIVATE button. If the user does not have an account, the user may initiate an account establish sequence by pressing ACTIVATE three times. At step 604, the meter logic prompts user to enter telephone number on the keypad. At step 606, the user enters the telephone number.

At step 608, the logic branches. At step 612, if the ACTIVATE button is pressed three times, the meter logic asks user to enter four digits of Social Security (SS) number, as a means to identification, to establish an account. At step 610, logic detects ACTVATE is pressed once. At step 614, the meter logic prompts for a entry of access code. At step 616, the user enters the access code. At step 618, the meter logic senses for a free telephone line and dials out a connection to the central system. At step 620, the meter logic sends the parking meter ID, the telephone number and the Access Code or SS number to the central computer system. At step 622, the central computer system receives data, validates it, initiates a timer and sends an approval. At step 624, if new account data is validated by the central computer system, it sends an assigned access code to the meter logic to display for the user-driver. At step 626, the meter logic receives approval, may enable orange bulb flash and/or displays IN USE.

Preferably the access code 421 is a four digit alphanumeric code. For this reason, keys representing alphabets A to M are placed on the left and right side of the numeric keypad 317D as illustrated in FIG. 3B. Alternatively the access code may only be 4 digit numeric, as it is commonly and customarily used in ATM banking transactions. It may also be 5 or 6 digit numeric. It is believed that a 4 digit alpha-numeric access code is easy to remember for a period of time.

At step 628, at the end of the meter use, the user presses CANCEL button. At step 630, the logic displays prompt for access code and driver enters the access code. At step 632, the meter logic senses a free line and dials out, establishing an global computer network connection. At step 634, the meter logic sends in the meter Id and the access code to the central system. At step 636, the central computer system receives the data, validates it and ends the timer. At step 638, the central computer system records a charge, using a specific meter rate from the meter database and sends the charge data to the meter logic. At step 640, the meter logic receives the data and terminates the connection. At step 642, the meter logic displays minutes used and money charged for some time. Then logic loops back to step 600.

With respect to FIG. 6B, it shows the logic of dual-use of the parking meter, where it accepts coins. At step 650, the meter logic detects coin drop and receives coin amount drop data from the coin sensor. At step 652, the logic connects to central system and sends meter Id and coin amount. At step 654, the central system updates the coin box fill status, computes time for the meter and sends it back to the meter for display. At step 656, the central system sends time expired status to the meter. At step 658, the meter logic performs periodic diagnostics and sends data to central computer system. At step 660, the central system aggregates coin box data and diagnostic status data and makes it available to the city over global computer network.

In summary, the method and apparatus 10 discloses a parking meter system having a (I) parking meter and a (ii) central system on a global computer network, wherein the parking meter is activated by the central system. The parking meter is adapted with a cellular telephone device with an embedded central processing unit with parking meter function, whereby the function interfaces with the central computer system for the purpose of activation/deactivation of the parking meter and in collection of parking fees. The invention also discloses a dual-use parking meter system where the parking meter may have a coin box, a coin insertion slot with a coin sensor, and a coin status function logic embedded in the adapted telephone device, wherein on inserting coins for parking fee payment, the central system is able to send meter use status for display in the adapted cellular telephone device's display screen.

While the particular apparatus 10 and method as illustrated herein and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Therefore, what is claimed is:

1. A parking meter system having a parking meter and a central system on a global computer network, wherein the parking meter is activated by the central system.

2. The parking meter system as in claim 1, wherein the parking meter having a cellular telephone device adapted with an embedded central processing unit with parking meter function logic, whereby the logic interfaces with the central computer system for the purpose of activation and deactivation of the parking meter.

3. The parking meter system as in claim 2, wherein the adapted telephone device having an alphanumeric keypad, whereby the parking fee payment is made by keying on the keypad a billing reference number and an identification reference number.

4. The parking meter system as in claim 3, where the adapted telephone device having a display screen, wherein meter use status is displayed on the display screen.

5. The parking meter system as in claim 4, wherein, the parking meter additionally having a coin box with a coin insertion slot with a coin sensor, and a coin status function logic embedded in the adapted telephone device, wherein on inserting coins for parking fee payment, the central system sending meter use status for display in the display screen.

6. The parking meter system as in claim 5, wherein the adapted telephone device having a plurality of telephone channels, thereby enabling a group of parking meters installed in a geographic area to share the same plurality of telephone channels.

7. The parking meter system as in claim 6, where the central system interfacing with the parking meter function logic and maintaining parking meter status.

8. The parking meter system as in claim 7, where the parking meter status including: a static database with parking meter identification, meter ownership identification, parking meter rate attributes; and a dynamic database with meter use status, and a billing reference.

9. The parking meter system as in claim 8, wherein the billing reference having a user telephone number and a user identification number, whereby the user is identified to the central system by the identification number and is billed for the parking fees by the telephone number.

10. The parking meter system as in claim 9, wherein a user activating the parking meter by entry of the billing reference number and the identification number and subsequently canceling the meter by entry of the identification number.

11. The parking meter system as in claim 10, wherein a user is billed the parking fees by multiplication of the time used in whole minutes and a per minute meter rate.

12. The parking meter system as in claim 11, wherein a user is billed the parking fees by transferring the fees to a telephone company of the user and the user pays the fees as a payment to the telephone company.

13. The parking meter system as in claim 12, wherein the central system effects an electronic fund transfer from the telephone company to the city of aggregated parking fees.

14. The parking meter system as in claim 13, wherein the central system extracting a group of parking meters' specific static and dynamic data and delivering to a city's computer system.

15. The parking meter system as in claim 14, wherein the city's computer system is a mobile device and the specific data is delivered wirelessly.

16. A dual use mode parking meter system comprising:
(a) a parking meter having a cellular telephone device adapted with an embedded central processing unit with parking meter function logic, the adapted telephone device having an alphanumeric keypad and a display window;
(b) a central computer system on a global computer network, whereby the logic interfaces with the central computer system via the adapted cellular telephone device, wherein parking fee payment is made by keying on the keypad a billing reference number and an identification reference number and the central system sending meter use status for display in the display window; and
(c) the parking meter additionally having a coin box, a coin insertion slot with a coin sensor, and a coin status function logic embedded in the adapted telephone device, wherein on inserting coins for parking fee payment, the central system sending meter use status for display in the display window.

17. The parking meter system as in claim 16, wherein the central system extracting a group of parking meters' specific data and delivering to the city's computer system.

18. The parking meter system as in claim 17, wherein the city computer system is a mobile device and the specific data is delivered wirelessly.

19. The parking meter system as in claim 18, wherein the adapted telephone device having a plurality of telephone channels, thereby enabling a group of parking meters installed in a geographic area to share the same plurality of telephone channels.

20. A method of using a parking meter comprising the steps of: a user activating the meter by entering a billing number and an access code, and deactivating the meter by entering the access code, whereby the meter displaying the minutes used and parking fee incurred.

21. A method of using a parking meter as in claim 20, further comprising the steps of: the parking fees become part of the user's telephone bill for payment and the user pays the parking fees by paying the telephone bill.
